(19) United States
(12) Patent Application Publication
(10) Pub. No.: US 2010/0320282 A1
(43) Pub. Date: Dec. 23, 2010

(54) INDEPENDENT FRAGRANCE SAMPLING SYSTEM

(76) Inventor: David Sissom, Hollywood, FL (US)

Correspondence Address: BUCHANAN INGERSOLL & ROONEY PC, P.O. BOX 1404, ALEXANDRIA, VA, 22313-1404, US

(21) Appl. No.: 12/515,700

(22) PCT Filed: Nov. 21, 2007
(86) PCT No.: PCT/US07/24322

§ 371 Date: Sep. 8, 2010

Related U.S. Application Data
(60) Provisional application No. 60/860,304, filed on Nov. 21, 2006.

(51) Int. Cl. A24F 25/00; B23P 19/04

(52) U.S. Cl. 239/34; 29/700

(57) ABSTRACT

Embodiments of the invention relate, for example, to a self-contained unit that contains a fragranced, scented or aroma emitting substance for on-demand and controlled-release sampling. The unit can be attached to or incorporated with any packaged, item, product, fixture device or other medium. Embodiments allow consumers or users to sample fragrances, scents and aromas of a product or item without opening the packaging, item or product therein preserving the integrity of the packaged items and products and keeping seals intact. Fragrances of products and the fragrance sample can be the same fragrance, or of different fragrances or scents to expose customers to available choices.

### CLAIM TO PRIORITY

This application claims priority to U.S. Provisional Patent Application No. 60/860,304, filed on Nov. 21, 2006, and having David Sissom as a common inventor. That application is incorporated by reference as if fully rewritten herein.

### STATEMENT OF FEDERALLY SPONSORED RESEARCH

None.

### BACKGROUND OF THE INVENTION

The following includes information that may be useful in understanding the present teachings. It is not an admission that any of the information provided herein is prior art, or material, to the presently described or claimed subject matter, or that any publication or document that is specifically or implicitly referenced is prior art.

### Field of the Invention

Embodiments of the invention relate to providing sample fragrances. These may be, for example, for personal care items, perfumes, shampoos, conditioners, soaps, household goods, air fresheners, auto products, candles, cleaners, detergents, food and beverage products, aerosols or any item or product that contains a fragrance, scent or aroma emitting substance wherein the item or product being promoted, demonstrated, offered or sold is packaged or sealed in a self contained unit, package, container, cylinder, bottle, jar, box, bag or other chamber.

### Background of the Art

The sales of many items are largely dependent on their fragrance. In the past, it has been difficult for a consumer or wholesale purchaser to evaluate the fragrance of an item without opening a package, spraying an aerosol, and/or consuming some of the product meant to be sold. It would be desirable to provide an apparatus that would allow a person to sample the fragrance of a product without consuming the product. It would also be desirable to provide the fragrance of a product independent of the product or its packaging.

A number of solutions have been proposed for allowing fragrance sampling. For example, WIPO publication no. WO2006/060559, to Brookes, et al., reports a two-compartment package for containing an air freshener and a fragrance.

### BRIEF SUMMARY OF THE INVENTION

The terms “Independent Fragrance Sampling System” or “IFSS” are used herein to refer to embodiments of the invention. Although given the name “system,” an IFSS may be a device. In one embodiment, an IFSS is a self-contained unit that contains a fragranced, scented or aroma emitting substance for on-demand and controlled-release sampling that can be attached to or incorporated with any packaged, item, product, fixture device or other medium. An IFSS allows consumers or users to sample fragrances, scents and aromas of a product or item without opening the packaging, item or product therein. This may preserve the integrity of the packaged items and products and keep seals intact. Fragrances of products and an IFSS fragrance sample can be the same fragrance, or of different fragrances or scents to expose customers to available choices.

In one embodiment, the invention provides a device for containing and releasing fragrance, comprising a housing, with the housing defining a cavity containing a fragrance; at least one vent, with the vent placing the cavity in communication with an atmosphere; and an actuator. The actuator may be operably connected to the vent. The actuator may be integral to the housing. In a further embodiment the vent has an open state and a closed state, and the actuator can place the vent in an open state. The transition from closed to open may be reversible or irreversible.

In a further embodiment the actuator creates pressure and displaces fragranced air from within the housing. In a still further embodiment, the actuator creates sufficient pressure to displace fragranced air contained within the housing. In a yet still further embodiment, the actuator is actuated by compression, and compression forces fragrance through the vent when the vent is in the open state.

Another embodiment provides a device wherein the actuator exposes the fragranced area in the housing. In further embodiments, the vent may be selected from the group consisting of a cylinder, slot, hole, channel, and tube.

In another embodiment, the actuator is selected from a pressure sensitive dome, arch, bubble, blister, a tab, a button, a slide, cover, lid, snap, hatch, port, door, a lifting cap, and a rotating cap. The fragrance may be present in a carrier, wherein the carrier is contained within the cavity.

The actuator may alternate the vent between its open state and closed state. The transition from closed state to open state can be reversible or not reversible by the actuator. A further embodiment provides an array for containing and releasing multiple fragrances, wherein the array comprises a plurality of devices as taught herein.

In a further embodiment the housing comprises a mounting area, and the mounting area comprising an adhesive or epoxy. The device may be attached to a product, package, fixture, or display, to provide a fragrance sample. The device may be attached, for example, by molding, contouring, wrapping, taping, clipping, tying, stapling, snapping, welding, adhesion or boxing.

In another embodiment the interior and exterior wall of the pressure sensitive actuator area has support ridges or stabilizing channels that are oriented from the top of the pressure responsive manipulator and extend along the structure to or throughout the base of the actuator. In a further embodiment, the interior and exterior structure of the pressure sensitive actuator area have at least one compression ring oriented throughout the top to the base of the actuator. In a further embodiment the interior and exterior structure of the pressure sensitive actuator area have at least one baffle oriented along the structure from the top to the base of the actuator.

In another embodiment a plurality of vents are operably connected to a single actuator. In a still further embodiment, the fragrance is contained on a carrier and the carrier is disposed within the cavity. The carrier may be, for example, but is not limited to, ethyl vinyl acetate (EVA) pellets, EVA beads, blotter paper, pulp board, ceramic, wax, processed boards, fibrous boards, membranes, and a gel.

### BRIEF DESCRIPTION OF THE FIGURES

The following descriptions correlate with the attached numeric diagrams to offer a visual perspective which demonstrates the multiplicity of the independent fragrance sampling system invention.

FIG. 1 shows a variety of forms and shapes that can house the source for the fragrance, scent or aroma. Models shown operate from a press manipulation and show the device can be used as an independent unit, or attached or incorporated with a product through adhesion or other method described herein. They include an actuator 1, a vent 3 and a cavity 5. Embodiments may also include an adhesive backing 7. It should be noted that throughout the disclosure and drawings “actuator” and “actuator area” are used interchangeably, “vent,” “vent opening,” “exhaust,” “exhaust opening,” and “exhaust area” are used interchangeably, and “cavity,” “housing,” and “compartment” are used interchangeably.

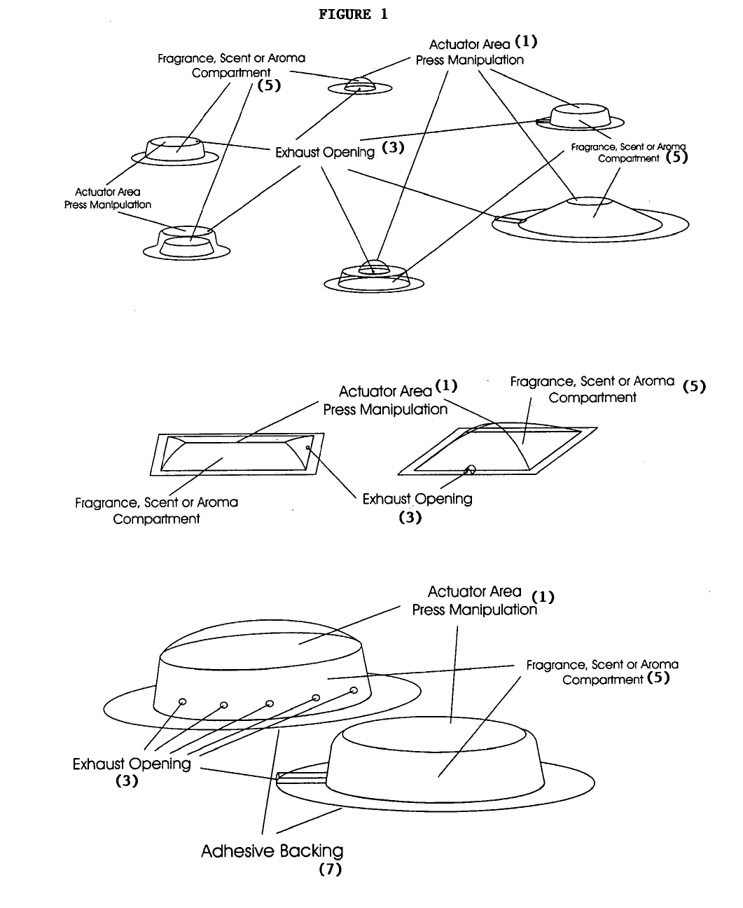

FIG. 2 shows a top angle view of an independent fragrance sampling system with a slide manipulation actuator 1 that exposes the vent openings 3 once it is slid or pulled from its closed position.

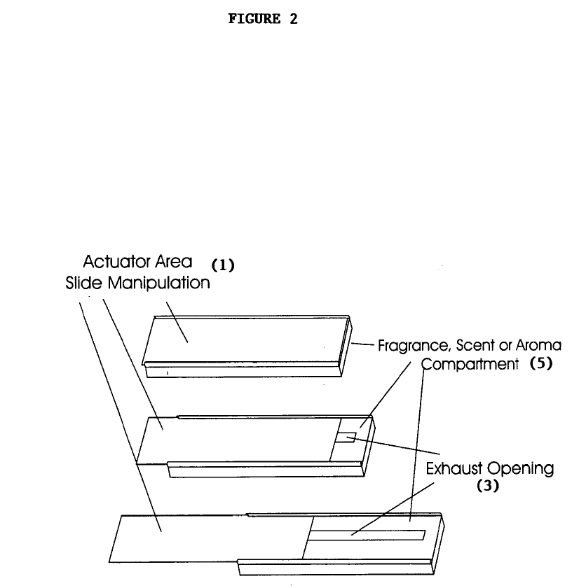

FIG. 3 shows a top view and angles side view of multiple compartment independent fragrance sampling system, which can offer an array fragrances, scents or aromas through individual vent openings.

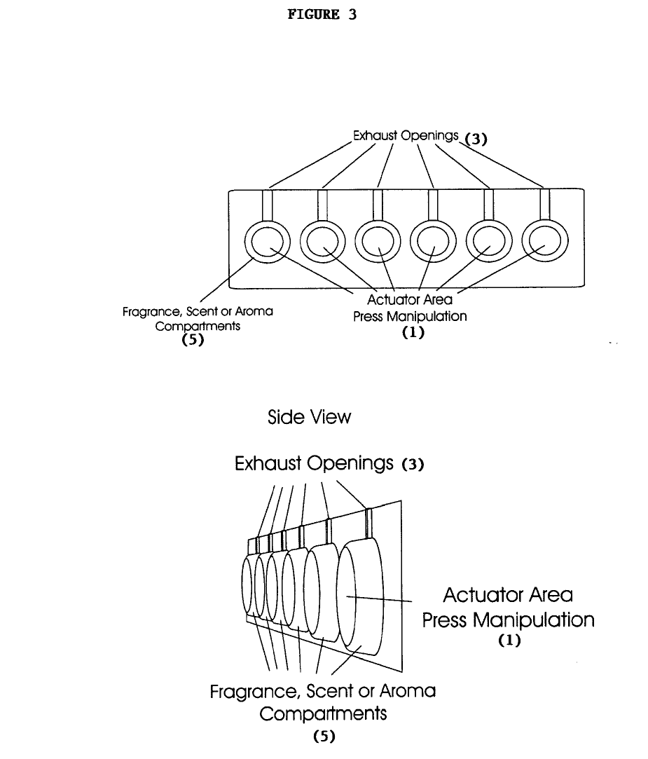

FIG. 4 shows an illustration of a folding chamber that releases a fragrance, scent or aroma upon lifting or unfolding the vent opening exposing the emitting substance.

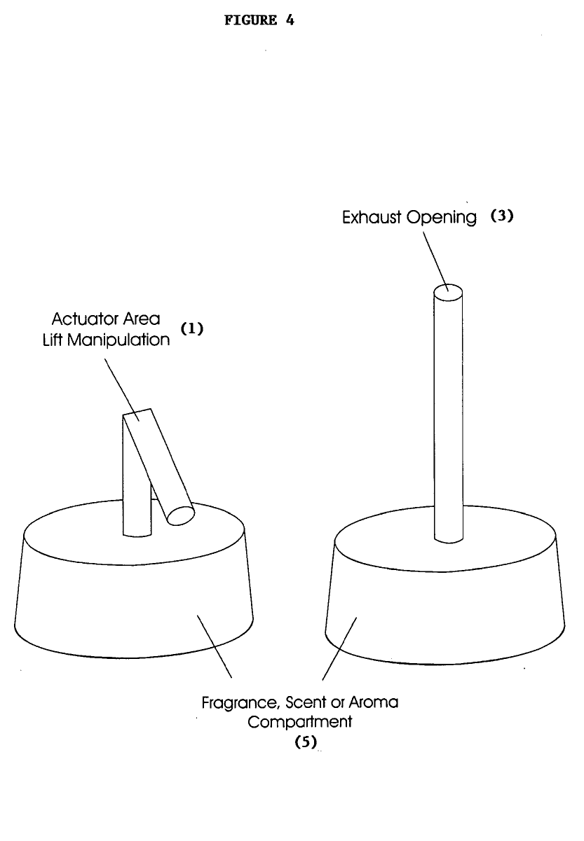

FIG. 5 shows an independent fragrance sampling system that uses a twist to manipulate the top 1 so the vent opening 3 can be released. Also, this diagram includes a view with the top 9 removed showing a multiple compartment system, however, it can be a single compartment as well. A transparent top 11 is also shown.

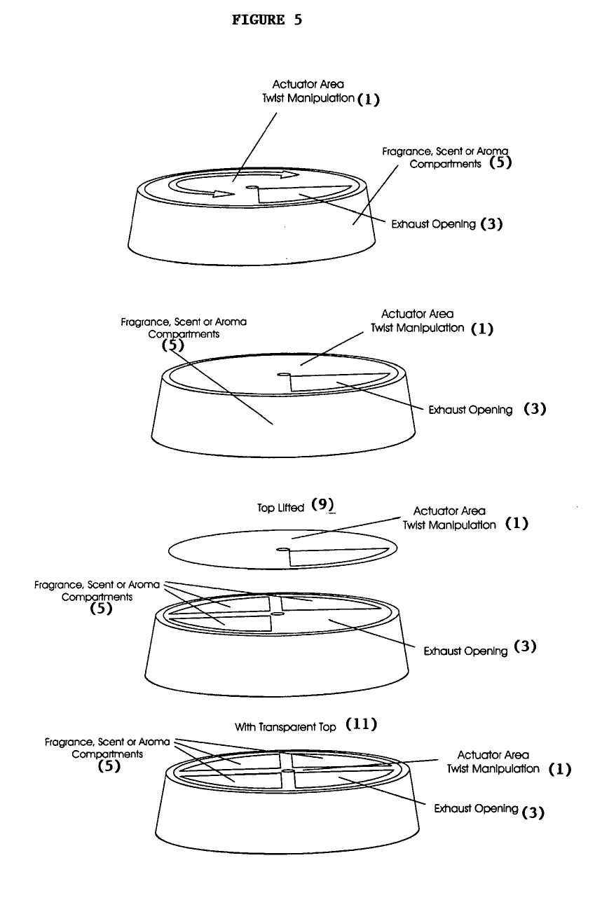

FIG. 6 shows an example of a hinged lid 1 that must be open and closed with a snap 13 to expose the vent opening. Its cavity 5 is designed to hold virtually any fragrance, scent or aroma substance.

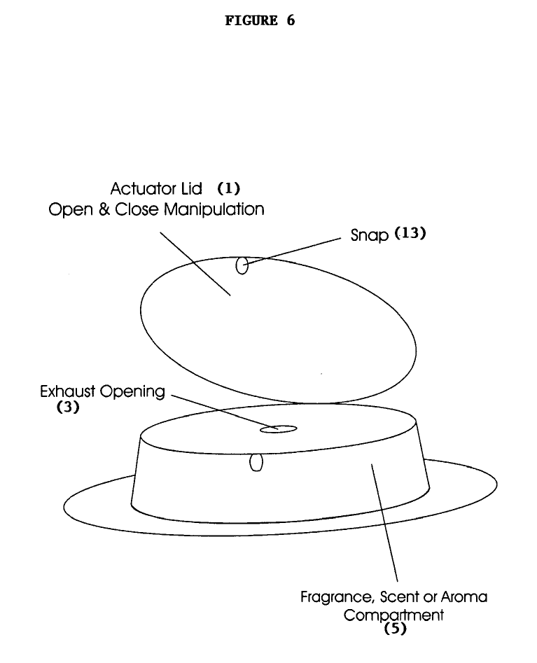

FIG. 7 shows a tubular independent fragrance sampling system utilizing a squeeze actuator 1 wherein the tubular form contains the fragrance, scent or aroma substance which is released through the exposed vent 3.

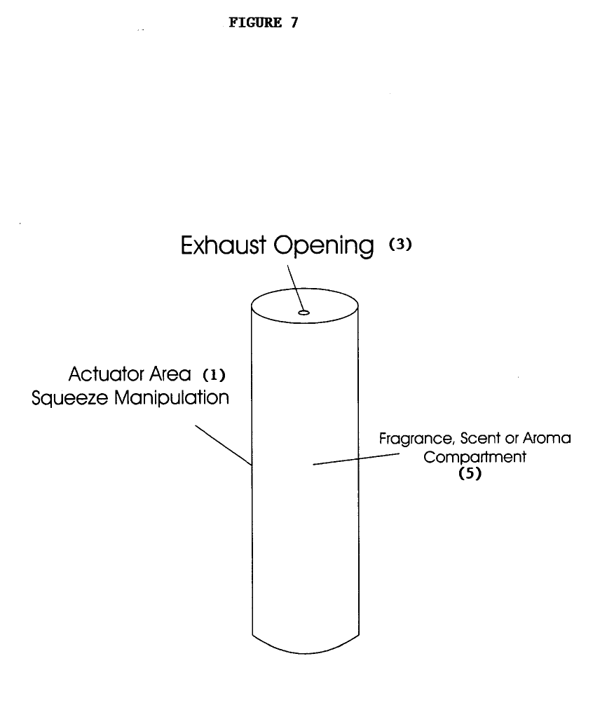

FIG. 8 shows an independent fragrance sampling system wherein the retractable actuator 1 must be pulled to sample the fragrance, scent or aroma in cavity 5.

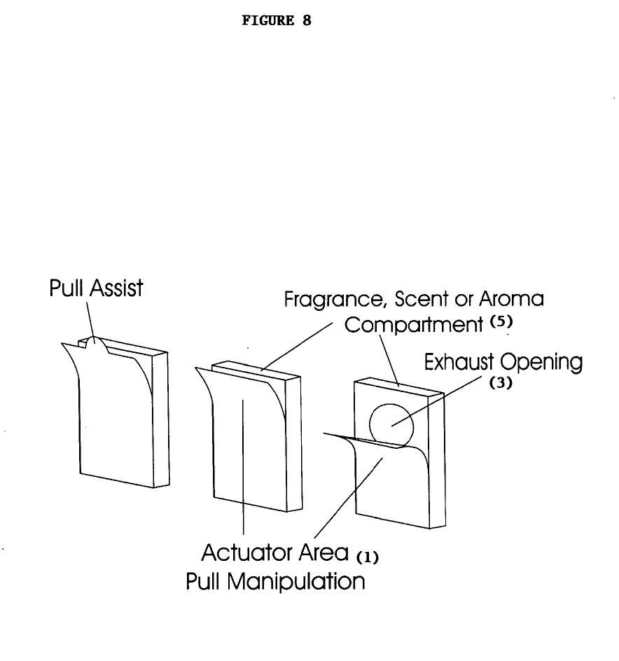

FIG. 9 shows a tubular independent fragrance sampling system which is activated with pressure manipulation.

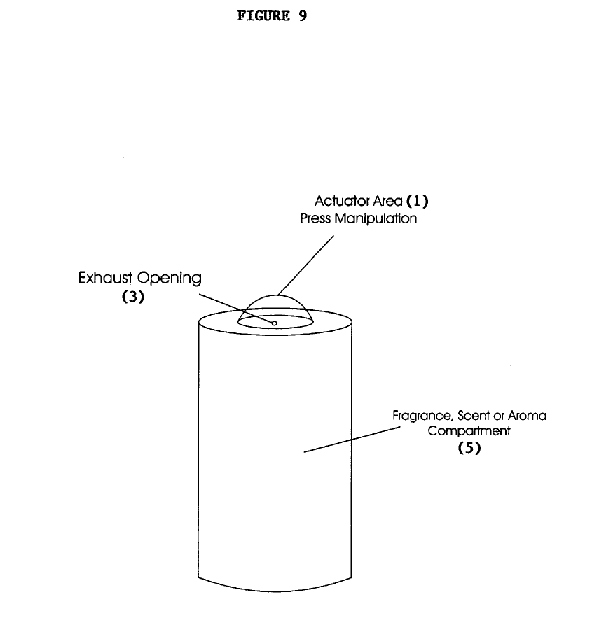

FIG. 10 shows a perspective of a couple press manipulation actuator systems. It shows a variety of vents. These models are for curved, convexed or irregular shape products or packaging. An independent fragrance sampling system applied to a lid 15 is also illustrated.

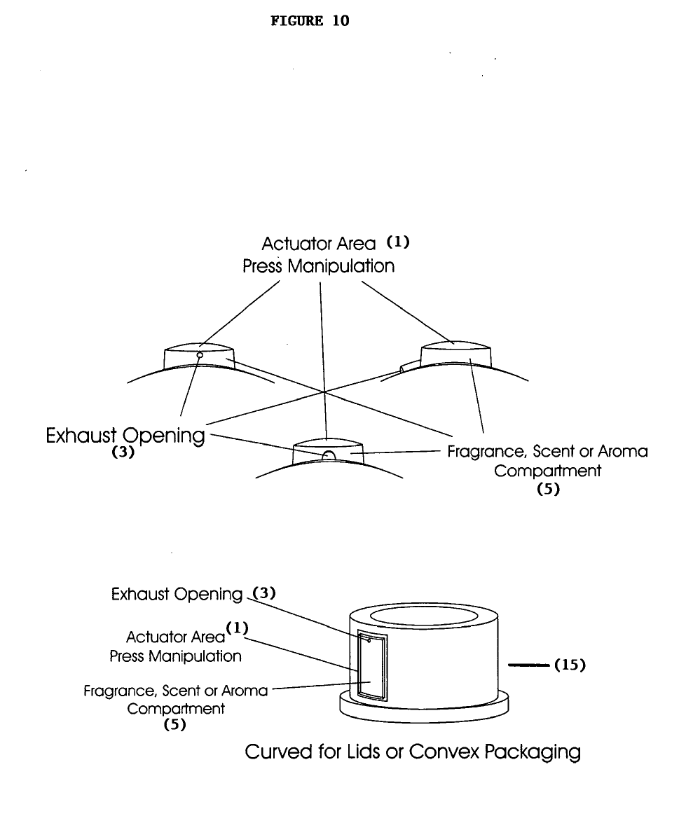

FIG. 11 shows an independent fragrance sampling system that is pressed through a piece of tape, vinyl, cardboard or other material 17 to allow the exposure of the system. The actuator area 1 and the vent 3 will extend through the material to allow access. This design offers the independent fragrance sampling system the flexibility to be incorporated or added to virtually any type of packaging.

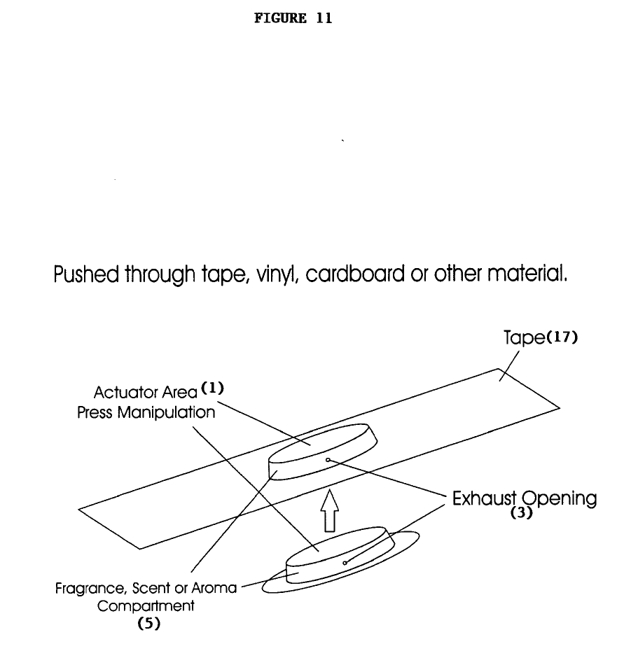

FIG. 12 shows a dimensional view of a multiple compartment independent fragrance sampling system that uses a lid actuator 1 to allow an array of fragrances, scents or aromas to be sampled one at a time through individual vents 3.

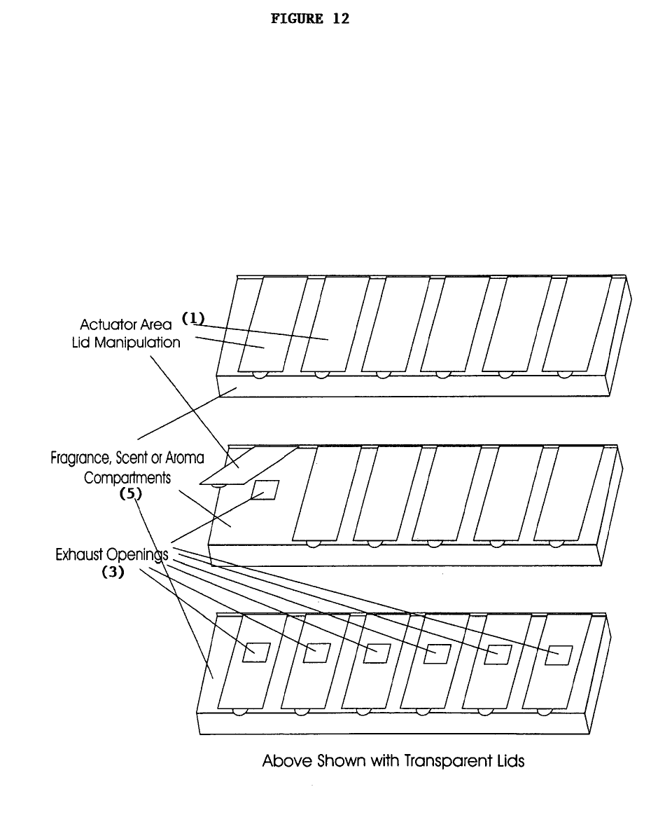

FIG. 13 shows multiple designs from a top angled side view capturing compression rings and baffles on and around the actuator to reduce collapsing, offer structural support and extended use for high volume sampling. The rings and baffles can be an array of forms, directions and patterns to create a spring-back effect.

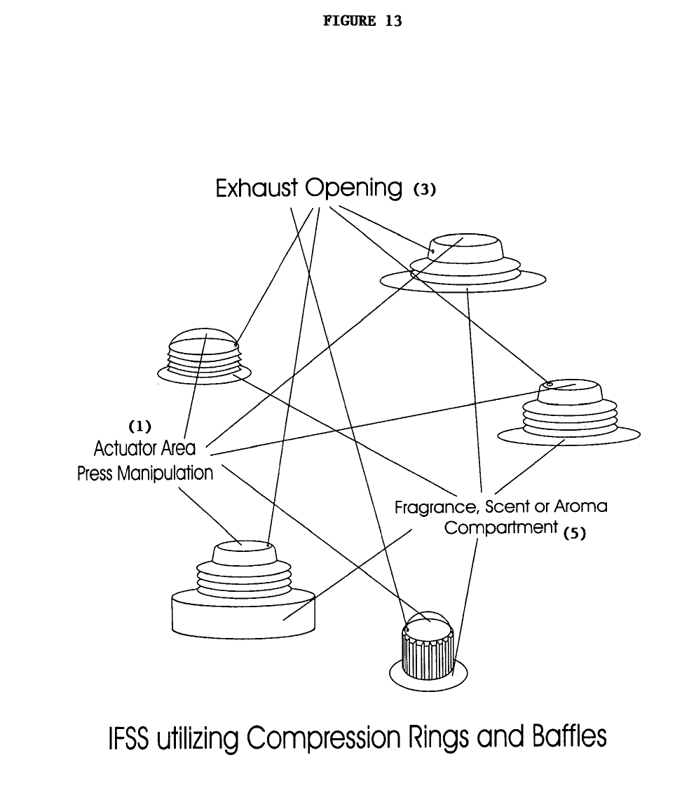

FIG. 14 shows an IFSS utilizing support ridges 19 and stabilizing channels 21 to the structure of pressure sensitive actuator 1. These offer support and strength to reduce collapsing upon compression of the manipulated area. This additional rigidity allows the actuator 1 to handle extended manipulation.

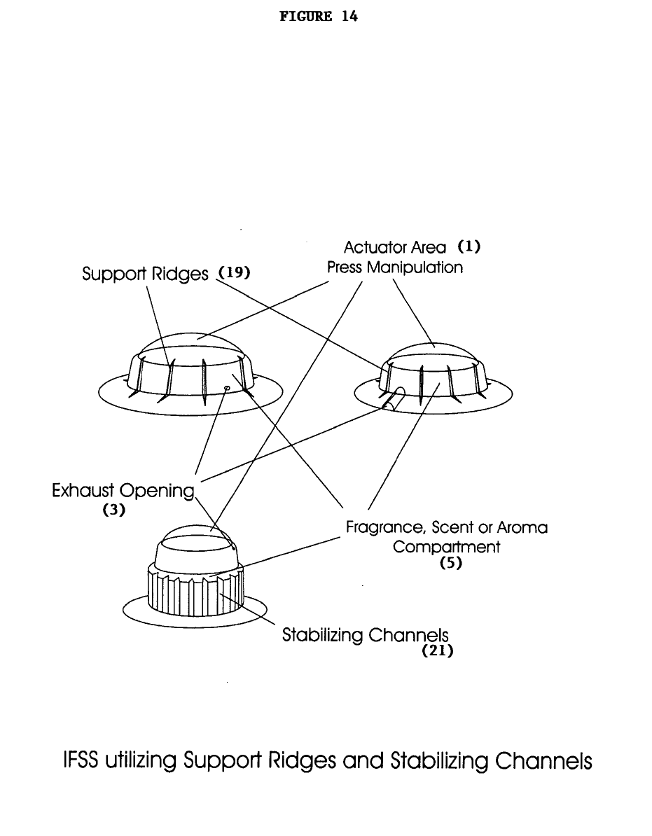

FIG. 15 shows an IFSS with a separated fragrance, scent or aroma compartment connected to the actuator via a free flowing air channel. The exhaust opening can be positioned near of the actuator, the fragrance, scent or aroma compartment or in proximity to the unit.

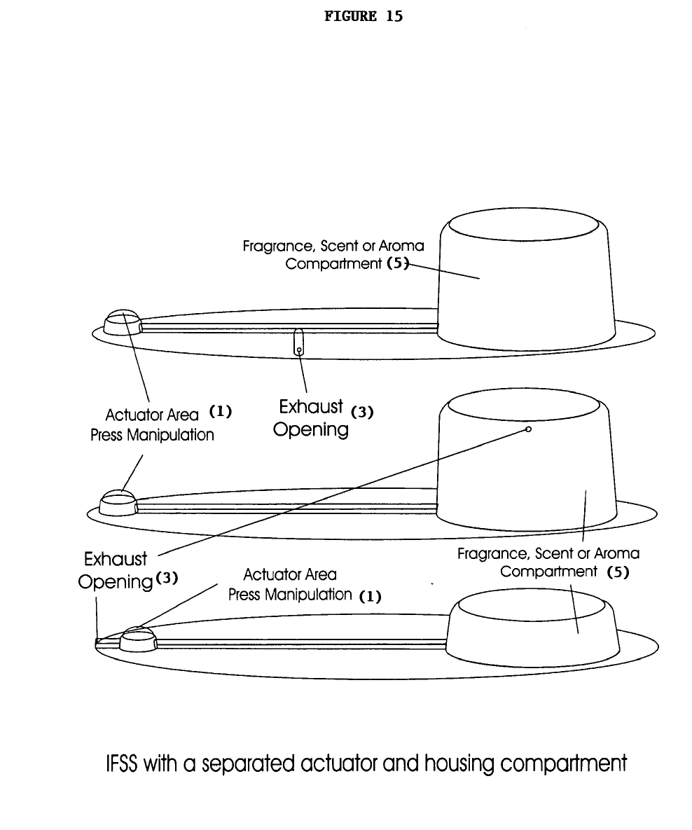

FIG. 16 shows IFSS's with multiple exhaust openings extending from one fragrance, scent or aroma compartment and operating from one pressure sensitive actuator. This reduces the need for a consumer or user to position themselves exactly at the end of one exhaust opening. The multiple openings release a wider range of fragrance, scent or aroma to be sampled and the consumer or user can experience the release from a further distance away from the system.

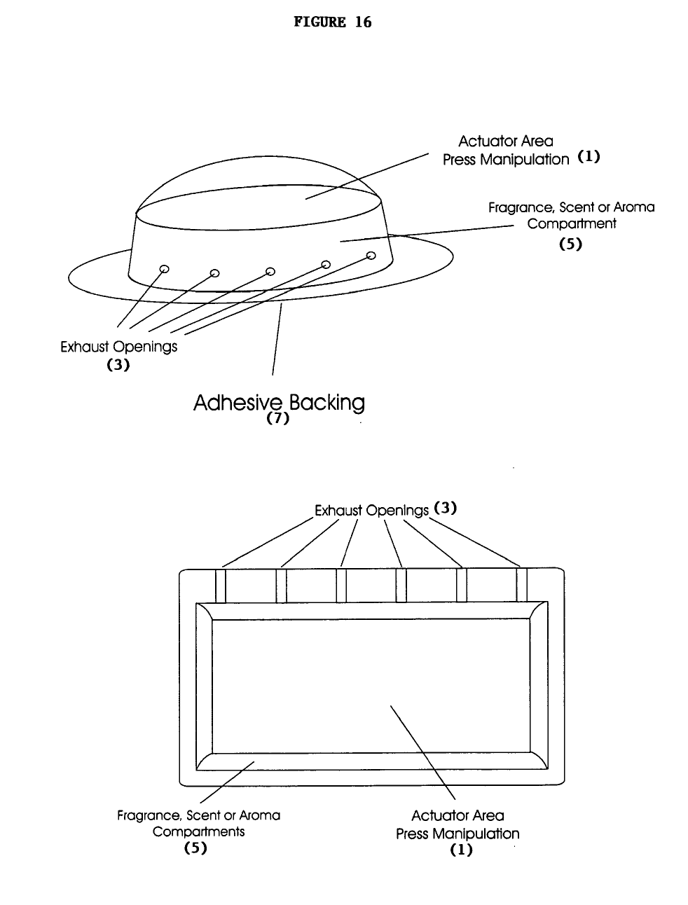

### DETAILED DESCRIPTION OF THE INVENTION

The present teaching describes several different features and aspects of the invention with reference to various exemplary embodiments. It is understood, however, that the invention embraces numerous alternative embodiments, which may be accomplished by combining any of the different features and aspects described herein in any combination that one of ordinary skill in the art would find useful.

An IFSS component can be attached or connected directly to a product, item or packaging in a multitude of techniques described later, or used in or on a separate device that can be displayed in proximity to the product to allow the consumer to sample the individual or multiple fragrances, scents or aromas available. An IFSS can also be made available, presented, given, shipped or mailed as a self-contained unit without the product to allow manufacturers or any others an opportunity to use an IFSS in a variety of situations and conditions. These include, but are not limited to research, testing, product management, and marketing as a tool to introduce customers or users to current, new or potential fragrances, scents, flavors, or aromas of items or products.

Since the consumer or user will have access to sample the fragrance, scent or aroma without disturbing the package, item or product, an IFSS is a cost-efficient tool. It offers the potential for increased savings in marketing, product development, consumer research, testing, surveying, sampling and shipping, because it alleviates the potential for missing or lost components, broken tamper seals, spoilage, leakage or spillage, opened packaging, or damaged packaging and/or items or products, any of which can impede the sale or use of an item. An IFSS allows the item or product to maintain its integrity and freshness, and allows the package to remain sealed and intact while providing the purchaser or user the opportunity to smell and sample the fragrance, scent or aroma used or contained in the product or item prior to using or purchasing it. In a situation where users or consumers may be familiar with an existing item or product, a manufacturer or marketer can obtain valuable feedback on new, experimental or potential fragrances, scents or aromas prior to producing a finished product.

The fragrances, scents or aromas of the item or product and the fragrance, scent or aroma contained in an IFSS can be one in the same, or an IFSS can have multiple segments, sections or compartments containing multiple fragrances, scents or aromas, to introduce entire product lines when necessary.

1. Functionality

An IFSS is a self-contained unit that has an actuator area that can be made with a wide variety of releasing mechanisms. These mechanisms can be manipulated to create a sampling of the fragrance, scent or aroma contained in an IFSS. The release mechanisms can vary in form and design but is not limited to the following methods: It can form a pressure responsive button, cylinder, channel, chamber or actuator area on the unit. This mechanism or actuator area can include or can be shaped to form a bubble, blister, convexed, domed, raised, arch or other compression shapes or other flexible and retracting area or chamber that can be manipulated by compression with a finger or other pressure or a slight squeeze. This decreases the volume of air in an IFSS unit, allowing a puff or waft of scented or fragranced air to be release into the surrounding air through one or multiple exhaust openings.

In addition to a pressure responsive area the actuator area can also form a cover, lid, snap, stem, vent, hatch, tray, door, port, slide or the like that can be manipulated to expose or open the venting area on an IFSS and reseal. A simple slide, pull, twist, lift or other process will open and expose the venting for self-contained sample of the fragrance, scent or aroma that is contained in an IFSS allowing the air surrounding the unit to be permeated with the fragrance, scent or aroma so it can be sample.

The actuator area mechanisms are designed of a rupturable, formable, durable, retractable, flexible, and/or memory materials, and other materials mentioned later, while its design can vary in shape, size, thickness, dimensions, stiffness, hardness, form, structure and material according to product needs.

The exhaust openings release the fragrance, scent or aroma and can be formed or created as a vent, channel, tube, slit, hole or other opening located on an IFSS. These openings also assist in controlling the release load of the fragrance, scent or aroma.

In a further embodiment of the invention, multiple vents are connected to a single cavity and operated by one or more actuators. This allows dispersion of fragrance over a wider area than might be accomplished by use of a single vent/actuator combination.

Consumers can activate and experience the fragrances in an IFSS by simply following directions to “press”, “squeeze”, “retract”, “release”, “pull”, “slide”, “lift”, “twist”, “turn”, “push” or “open” the actuator and to “sniff” the venting portion of the unit. The design and function of an IFSS unit offers the portability to be attached to any packaging, package, display other device, while its design allows it to be a completely independent self contained fragrance sampling system. This gives a consumer or user the opportunity to experience the smell of the product's fragrance, scent or aroma before purchasing or using the product.

2. Utilizing an IFSS

An IFSS offers the flexibility to be incorporated, attached, integrated, combined or used in conjunction with or separately on virtually any shape, size or form of package, item or product. It can be placed in almost any position on the packaging, product or item containing the fragranced, scented or aroma emitting substance, or in a close proximity to it, on a shelf, fixture or other device. In most cases, an IFSS can be added without any or with minor alterations to existing packaging designs or current packaging, which can offer savings in labor, set-up, tooling and production costs.

3. Attaching IFSS to Package, Item or Product

An IFSS can be attached or incorporated to the package or packaging through multiple techniques, but is not limited to the following methods: mounted with an adhesive or epoxy, created or formed directly in the product's package, blister or clam shell, shaped contoured to package or products shape, molded to attach to package or product, shrink or plastic wrapped, taped, clipped, tied, stapled, snapped, welded, boxed or other process known to those skilled in the art to affix an IFSS to the product or item.

4. Non-Attached IFSS Placed in or on a Fixture or Device

An IFSS component does not have to be attached or connected directly to the packaging, item or product. It can also be affixed to, incorporated with or placed in or on a separate fixture or device such as shelving, counters or displays or other substances to allow for fragrance, scent or aroma sampling away from product, packaging or items. The fixture or device can be in any shape, size or design and constructed out of virtually any material to merely hold an IFSS so that it can be positioned or displayed in a proximity to the item's or product's area to allow the user or consumer sampling. The fixture or device can be designed to hold one or an array of available fragrances, scents or aromas.

5. Portable Non-Attached IFSS

An IFSS offers invaluable portability because it does not have to be (though it may be) attached or connected with the package, item or product. An IFSS's portability allows the unit to be used independently from any packaging or fixture, which gives the ability to use, give or send samples of fragrances, scents or aromas without having an actual item or product attached to an IFSS. The portability allows an IFSS to be used as a hand-held unit for demonstrations, sampling, giveaways, mailing or other uses. For example, a perfume sales clerk can manipulate the activator on an IFSS and allow a customer or others to smell one perfume or an entire line. An IFSS can be distributed, used, shipped or mailed as an individual marketing tool to expose or introduce fragrances, scents or aromas of products and or new potential products.

6. Size

An IFSS can be made in virtually any size. This flexibility allows it to be used with very small to very large packages, items and products. The size of an IFSS also controls the fragrance released and the amount of uses the unit can dispense. A smaller IFSS is ideal for sampling by a small number of individuals while a larger unit can support high volume of uses and offers a longer shelf life of the sample fragrance, scent or aroma.

7. Shape

An IFSS is not limited to a specific shape, so long as it is able to contain and release fragrance and satisfies any other requirements herein. This enables it to be used on any package, item or product. Versatility of shape allows for the unit to conform to or to be attached to irregular shapes and surface areas, smooth or rough surfaces, and be placed or positioned on any area of the package, item or product.

8. IFSS Composition

An IFSS can be manufactured from but is not limited to any of the following process' thermal formed, vacuumed formed, injection molded, cast, blow molded or heat-sealed. An IFSS can be constructed from of a multitude of materials ranging from but not limited to Polyethylene terephthalate (also known as PETG or PET), polyvinylchloride, polypropylene (PP), polyvinylidene chloride (PVDC), vinyls, natural and synthetics, resins, fibers, coated substrates, membranes, or other materials known to those skilled in the art. The materials can be in any form from roll stock, sheet, pellet, film form, solid or others.

Fragrance, Scent and Aroma Producing Material

An IFSS's fragrance, scent or aroma can be managed, stored or contained by a carrier. Exemplary carriers include but are not limited to ethyl vinyl acetate (EVA) pellets or beads, blotter paper or material, pulp board, ceramic, wax, processed boards, fibrous material and boards, membranes, or other material known to those skilled in the art, which have been permeated with synthetic or essential oils, fragrances, scents and/or aromas. In a preferred embodiment, a gel carrier is used, wherein the gel is added to the IFSS as a liquid and solidifies before use. In addition, the actual material or formula from the article or product may also be used as the fragrance fill in an IFSS.

An IFSS gives the manufacturer or marketer the ability to offer users and customers the opportunity to evaluate the fragrance, scent or aroma of their item or product to assist them in forming an opinion about the item or product before purchasing or using the item. An IFSS is a simple system for users and consumers to activate, and it allows the manufacturer or marketer to easily adapt or integrate an IFSS unit to their packaging, item or product, while offering savings in marketing, product development, consumer research, testing, surveying and sampling and shipping.

An IFSS is a totally self-contained unit. It is adaptable and flexible for use in conjunction with nearly any products, items and packaging or it can stand alone as a separate unit and does not have to be part of the packaging. An IFSS can be incorporated with items such as, but not limited to; bottles, jars, boxes, packages, containers, cylinders, bottles, jars, canisters, boxes, bags or other chambers that do not contain a sandwiched layer. Further, it does not have to be included with any product, if, for example, it is used as a sampling device. It is well suited to be incorporated in fixtures, display units and other devises. Also, an IFSS was designed to encompass one or numerous fragrances by utilizing one or multiple compartments.

An IFSS may have one or more actuator areas for release of the fragrances, scents or aromas through multiple functions and forms. For example, an IFSS can be activated in a multitude of fashions including but not limited to a “squeeze,” “retract,” “release,” “press,” “pull,” “slide,” “lift,” “twist,” “turn,” “push,” or “open” to expose the fragrance, scent or aroma through the venting portion of the unit. In addition to a pressure responsive area, the actuator areas can form a cover, lid, snap, stem, vent, hatch, tray, door, port, slide or others actuators.

Patents, patent applications, publications, scientific articles, books, and other documents and materials referenced or mentioned herein are indicative of the levels of skill of those skilled in the art to which the inventions pertain, as of the date each publication was written, and all are incorporated by reference as if fully rewritten herein. Inclusion of a document in this specification is not an admission that the document represents prior invention or is prior art for any purpose.

The terms and expressions employed herein have been used as terms of description and not of limitation, and there is no intention in the use of such terms and expressions, or any portions thereof, to exclude any equivalents now know or later developed, whether or not such equivalents are set forth or shown or described herein or whether or not such equivalents are viewed as predictable, but it is recognized that various modifications are within the scope of the invention claimed, whether or not those claims issued with or without alteration or amendment for any reason. Thus, it shall be understood that, although the present invention has been specifically disclosed by preferred embodiments and optional features, modifications and variations of the inventions embodied therein or herein disclosed can be resorted to by those skilled in the art, and such modifications and variations are considered to be within the scope of the inventions disclosed and claimed herein.

Specific methods and devices described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. Where examples are given, the description shall be construed to include but not to be limited to only those examples.

It will be readily apparent to one skilled in the art that varying substitutions and modifications may be made to the invention disclosed herein without departing from the scope and spirit of the invention, and from the description of the inventions, including those illustratively set forth herein, it is manifest that various modifications and equivalents can be used to implement the concepts of the present invention without departing from its scope. A person of ordinary skill in the art will recognize that changes can be made in form and detail without departing from the spirit and the scope of the invention. The described embodiments are to be considered in all respects as illustrative and not restrictive. Thus, for example, additional embodiments are within the scope of the invention and within the following claims.

I claim:

1. A device for containing and releasing fragrance, comprising:
a. a housing, said housing defining a cavity containing a fragrance;
b. at least one vent said vent placing said cavity in communication with an atmosphere;
c. an actuator.

2. The device of claim 1, wherein said vent has an open state and a closed state, and wherein said actuator places said vent in an open state.

3. The device of claim 1, wherein said actuator creates pressure and displaces fragranced air from within said housing.

4. The device of claim 1, wherein said actuator is integral with said housing.

5. The device of claim 1, wherein said actuator is actuated by compression, and wherein said compression forces fragrance through said vent when said vent is in the open state.

6. The device of claim 1, wherein said actuator exposes the fragranced area in the housing.

7. The device of claim 1, wherein said vent is selected from the group consisting of a cylinder, slot, hole, channel, and tube.

8. The device of claim 1, wherein said actuator is selected from the group consisting of a pressure sensitive dome, arch, bubble, blister, a tab, a button, a slide, cover, lid, snap, hatch, port, door, lifting cap, and rotating cap.

9. The device of claim 1, wherein said fragrance is present in a carrier, and wherein said carrier is contained within said cavity.

10. The device of claim 2, wherein said actuator alternates said vent between said open state and said closed state.

11. The device of claim 1, wherein the transition from said closed state to said open state can be reversible or not reversible by said actuator.

12. An array for containing and releasing multiple fragrances, said array comprising a plurality of devices of claim 1.

13. The device of claim 2, wherein the transition of said vent from said closed state to said open state is reversible.

14. The device of claim 2, wherein the transition of said vent from said closed state to said open state is not reversible by said actuator.

15. The device of claim 1, wherein said housing comprises a mounting area, said mounting area comprising an adhesive or epoxy.

16. A method for providing a fragrance sample, comprising attaching the device of claim 1 to an object selected from the group consisting of a product, package, fixture, or display.

17. The method of claim 16, wherein said device is attached to said object by at least one of molding, contouring, wrapping, taping, clipping, tying, stapling, snapping, welding, adhesion or boxing.

18. The device of claim 1, wherein the interior and exterior wall of the pressure sensitive actuator area has support ridges or stabilizing channels which are oriented from the top of the pressure responsive manipulator and extend along the structure to or throughout the base of the actuator.

19. The device of claim 1, wherein the interior and exterior structure of the pressure sensitive actuator area have at least one compression ring oriented throughout the top to the base of the actuator.

20. The device of claim 1, wherein the interior and exterior structure of the pressure sensitive actuator area have at least one baffle oriented along the structure from the top to the base of the actuator.

21. The device of claim 1, further comprising a plurality of vents operably connected to a single actuator.

22. The device of claim 1, wherein said fragrance is contained on a carrier and said carrier is disposed within said cavity.

23. The device of claim 22, wherein said carrier is selected from the group consisting of ethyl vinyl acetate (EVA) pellets, EVA beads, blotter paper, pulp board, ceramic, wax, processed boards, fibrous boards, membranes, and a gel.
